(19) United States
(12) Patent Application Publication
(10) Pub. No.: US 2026/0295504 A1
(43) Pub. Date: Oct. 1, 2026

(54) DAC APPARATUS

(71) Applicant: Honda Motor Co., Ltd., Tokyo (JP)

(72) Inventors: Hiroka Shigi, Saitama (JP); Masanobu Takazawa, Saitama (JP); Keisuke Shimizu, Saitama (JP)

(21) Appl. No.: 19/575,763

(22) Filed: Mar. 23, 2026

(30) Foreign Application Priority Data
Mar. 28, 2025 (JP) 2025-055212

(51) Int. Cl. B01D 53/04

(52) U.S. Cl. CPC B01D 53/0462; B01D 2256/22; B01D 2257/504; B01D 2259/40007; B01D 2259/40028; B01D 2259/40088

(57) ABSTRACT

A DAC apparatus to recover CO₂ in atmosphere, includes: an adsorption chamber provided with an adsorbent for adsorbing or absorbing CO₂; an atmospheric control valve to open the adsorption chamber to the atmosphere or seal the adsorption chamber; a vacuum pump connected with the adsorption chamber through vacuum piping; a vacuum control valve provided on the vacuum piping; a heating device to heat the adsorbent; a pressure sensor to detect pressure of the adsorption chamber; and a controller to control the atmospheric control valve, the vacuum control valve, and the heating device to sequentially perform an adsorption step, deaeration step, and desorption step. The controller ends the deaeration step when a state in which a change amount per unit time of pressure detected by the pressure sensor is equal to or smaller than a predetermined amount continues for a predetermined time after starting the deaeration step.

### CROSS-REFERENCE TO RELATED APPLICATION

This application is based upon and claims the benefit of priority from Japanese Patent Application No. 2025-055212 filed on Mar. 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, an apparatus that recovers CO₂ in the atmosphere using an adsorbent for adsorbing or absorbing CO₂ is known. For example, in the apparatus of JP 2024-048937 A, after the atmosphere is circulated into an adsorption chamber in which an adsorbent is provided to adsorb CO₂ in the atmosphere to the adsorbent, the inside of the adsorption chamber is deaerated by a vacuum pump for a certain period of time. Then, the adsorbent is heated to desorb CO₂ from the adsorbent, and a desorption gas having a high CO₂ concentration is recovered.

However, in a case where the deaeration time is made constant as in the apparatus described in JP 2024-048937 A, it is necessary to set a sufficiently long deaeration time in consideration of an environmental condition such as an outside air temperature, the operation efficiency may decrease, and thus CO₂ recovery efficiency may decrease as the entire apparatus.

### SUMMARY OF THE INVENTION

An aspect of the present invention is a DAC apparatus configured to recover CO₂ in the atmosphere, including: an adsorption chamber provided with an adsorbent for adsorbing or absorbing CO₂; an atmospheric control valve configured to open the adsorption chamber to the atmosphere or seal the adsorption chamber from the atmosphere; a vacuum pump connected with the adsorption chamber through vacuum piping; a vacuum control valve provided on the vacuum piping; a heating device configured to heat the adsorbent; a pressure sensor configured to detect a pressure of the adsorption chamber; and a controller configured to control the atmospheric control valve, the vacuum control valve, and the heating device to sequentially perform an adsorption step, a deaeration step, and a desorption step, the adsorption step circulating the atmosphere into the adsorption chamber and adsorbing CO₂ in the atmosphere to the adsorbent, the deaeration step deaerating and depressurizing the atmosphere in the adsorption chamber, the desorption step heating the adsorbent in a state in which the adsorption chamber is depressurized and desorbing CO₂ from the adsorbent. The controller ends the deaeration step when a state in which a change amount per unit time of the pressure detected by the pressure sensor is equal to or smaller than a predetermined amount continues for a predetermined time after starting the deaeration step.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a piping configuration of a DAC apparatus according to an embodiment of the present invention;

FIG. 2 is a block diagram schematically illustrating an example of a control configuration of the DAC apparatus according to the embodiment of the present invention;

FIG. 3 is a time chart for describing pressure changes in an adsorption chamber in a deaeration step;

FIG. 4 is a time chart similar to FIG. 3;

FIG. 5 is a diagram for describing a characteristic of a predetermined pressure shown in FIG. 4 in accordance with years of use of a vacuum pump; and

FIG. 6 is a flowchart illustrating an example of processing in the deaeration step performed by a controller shown in FIG. 2.

### DETAILED DESCRIPTION OF THE INVENTION

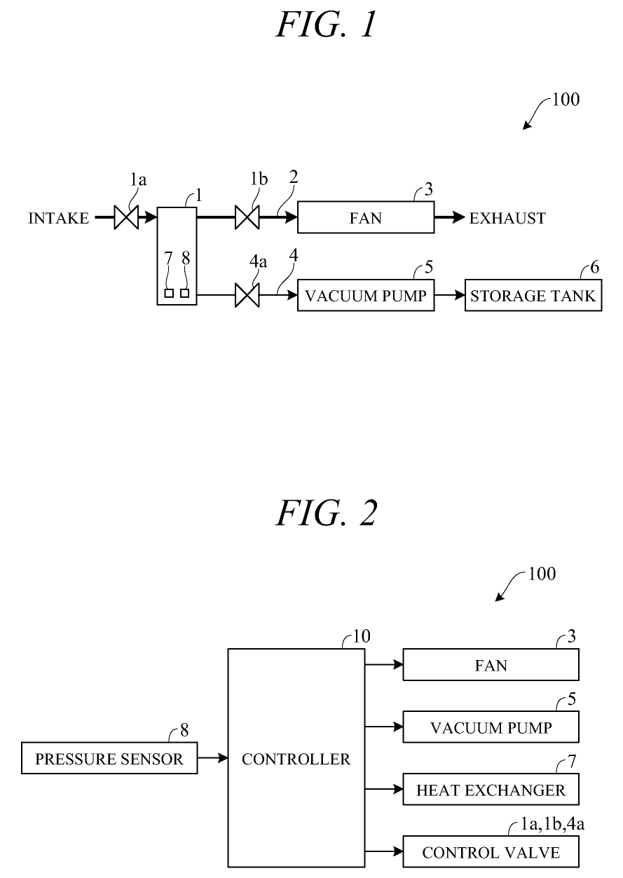

Hereinafter, embodiments of the present invention will be described with reference to FIGS. 1 to 6. FIG. 1 is a block diagram schematically illustrating an example of a piping configuration of a DAC apparatus 100 according to an embodiment of the present invention. As illustrated in FIG. 1, the DAC apparatus 100 mainly includes a reactor 1 in which an adsorbent for adsorbing or absorbing CO₂ is provided.

The reactor 1 includes a housing in which a sealed space (an adsorption chamber) can be formed, and an adsorbent is provided in the adsorption chamber of the reactor 1. As the adsorbent, a solid material composed to adsorb CO₂ at normal temperature and normal pressure and to desorb CO₂ as the temperature rises can be used. For example, an amine-based solid absorbent in which an amine-based compound is carried on an appropriate carrier can be used. The adsorbent is configured in an appropriate granular shape, is filled in a filter cartridge or the like having a mesh structure, for example, and is accommodated in the adsorption chamber of the reactor 1.

Atmospheric control valves 1a and 1b, which open the reactor 1 to the atmosphere or seal the reactor 1 from the atmosphere, are provided for the reactor 1. The atmospheric control valves 1a and 1b may be provided on piping that connects the adsorption chamber of the reactor 1 with an external space, or may be provided as a part of the housing (a wall surface) of the reactor 1. When the atmospheric control valves 1a and 1b are opened, the adsorption chamber of the reactor 1 is opened to the atmosphere. When the atmospheric control valves 1a and 1b are closed, the adsorption chamber of the reactor 1 is sealed. The atmospheric control valve 1a and the atmospheric control valve 1b are provided to face each other with the adsorption chamber interposed between them.

A fan 3 for circulating the atmosphere into the adsorption chamber of the reactor 1 is connected with the reactor 1 through appropriate piping (atmospheric piping) 2 and one of the atmospheric control valves 1a and 1b (the atmospheric control valve 1b in the illustrated example). In the illustrated example, when the atmospheric control valves 1a and 1b are open and the fan 3 is driven, the atmosphere is taken into the reactor 1 through the atmospheric control valve 1a, and the atmosphere is exhausted from the reactor 1 through the atmospheric control valve 1b, the atmospheric piping 2, and the fan 3. Thus, when the atmosphere circulates into the reactor 1, CO₂ in the atmosphere is adsorbed to the adsorbent in the adsorption chamber (an adsorption step). The atmospheric control valves 1a and 1b and the atmospheric piping 2 are each configured to have a relatively large diameter so as to enable a large amount of atmosphere to circulate into the reactor 1. A plurality of atmospheric control valves 1a and a plurality of atmospheric control valves 1b may be provided.

Vacuum piping 4 is further connected with the reactor 1. The vacuum piping 4 connects the adsorption chamber of the reactor 1 with an intake port of the vacuum pump 5 for CO₂ recovery. On the vacuum piping 4, a vacuum control valve 4a, which permits or prohibits the flow of gas in the vacuum piping 4, that is, the flow of gas from the reactor 1 to the vacuum piping 4, is provided. The vacuum control valve 4a may be made up of an on-off valve such as a ball valve, may be made up of an adjustment valve such as a butterfly valve, or may be made up of a combination of them. A storage tank 6 is connected with an exhaust port of the vacuum pump 5 through appropriate piping.

In the reactor 1, a heating device that heats the adsorbent and a cooling device that cools the adsorbent are provided. For example, a heat exchanger 7, which heats or cools the adsorbent using a heat medium, is provided. A pressure sensor 8, which detects pressure P in the reactor 1 (the adsorption chamber), is also provided.

When the adsorption step ends, the atmospheric control valves 1a and 1b are closed, and in addition, the vacuum control valve 4a is opened. When the vacuum pump 5 is driven, the gas in the adsorption chamber of the reactor 1 is sucked out by the vacuum pump 5 through the vacuum piping 4. Thus, the inside of the adsorption chamber of the reactor 1 is deaerated (a deaeration step).

When the deaeration step ends, the atmospheric control valves 1a and 1b are closed, and in addition, the vacuum control valve 4a is opened. In a state in which the vacuum pump 5 is driven, heating of the adsorbent by the heat exchanger 7 is started. Thus, the pressure P of the reactor 1 becomes lower than that at the time of adsorption, and in addition, the temperature of the adsorbent becomes higher than that at the time of adsorption. CO₂ that has been adsorbed to the adsorbent is desorbed, and the desorption gas mainly containing the desorbed CO₂ is sucked out of the reactor 1, is stored in the storage tank 6, and is recovered (a desorption step).

When the adsorbent is heated in the desorption step, if the temperature of the adsorbent rises in a state in which oxygen is present in the adsorption chamber, the adsorbent may be subject to oxidation deterioration. Before the desorption step accompanied with the temperature rise of the adsorbent starts, the deaeration step is performed to remove the residual atmosphere containing oxygen in the adsorption chamber. Thus, it becomes possible to prevent the oxidation deterioration of the adsorbent.

The deaeration step may be performed using the vacuum pump 5 for CO₂ recovery. However, a vacuum pump (a vacuum pump for deaeration) different from the vacuum pump 5 may be connected with the adsorption chamber of the reactor 1 through vacuum piping (vacuum piping for deaeration) different from the vacuum piping 4, and then the deaeration step may be performed using such a vacuum pump for deaeration. In this case, it is possible to exhaust the residual atmosphere that has been deaerated from the inside of the adsorption chamber of the reactor 1 through the vacuum pump for deaeration without guiding the residual atmosphere to the storage tank 6, so that the concentration of CO₂ recovered into the storage tank 6 can be further increased.

After the desorption step ends and before the adsorption step starts, a cooling step of cooling the adsorbent in the adsorption chamber of the reactor 1 is performed. When the atmosphere containing oxygen circulates into the adsorption chamber in a state in which the adsorbent has a high temperature, the adsorbent may be subject to the oxidation deterioration. By performing the cooling step of cooling the adsorbent before the adsorption step of circulating the atmosphere into the adsorption chamber, it becomes possible to prevent the oxidation deterioration of the adsorbent. In the cooling step, processing may wait until the temperature of the adsorbent decreases to fall within a temperature range in which an oxidation reaction does not proceed, but the adsorbent in the adsorption chamber may be cooled by the heat exchanger 7. In this case, the time necessary for the cooling step can be shortened, so that the DAC apparatus 100 can be efficiently operated.

In the deaeration step among the respective steps, it is difficult to determine whether deaeration has been completed, and it may take time. That is, the deaeration step has to be performed until the oxygen partial pressure in the adsorption chamber of the reactor 1 sufficiently decreases from the viewpoint of preventing the oxidation deterioration of the adsorbent. However, since the oxygen partial pressure changes depending on the environmental condition such as humidity, it is difficult to determine completion of the deaeration, based on the pressure P of the reactor 1. In addition, since the final ultimate pressure of the vacuum pump 5 also changes depending on the environmental condition such as humidity, it is also difficult to determine the completion of the deaeration, even though the pressure P of the reactor 1 decreases to a predetermined threshold. If it takes time to determine the completion of the deaeration, and the time necessary for the deaeration step becomes longer, the operation efficiency may decrease, and thus the CO₂ recovery efficiency may decrease as the entire apparatus. Therefore, in the present embodiment, the DAC apparatus 100 is configured as follows in such a manner that the completion of the deaeration is determined promptly to shorten the time necessary for the deaeration step, so that the CO₂ recovery efficiency of the entire apparatus can be improved.

FIG. 2 is a block diagram schematically illustrating an example of a control configuration of the DAC apparatus 100. As illustrated in FIG. 2, the DAC apparatus 100 includes a controller 10, which controls each unit of the DAC apparatus 100, which is illustrated in FIG. 1. The controller 10 is made up of a computer including a CPU, a ROM, a RAM, an I/O interface, and other peripheral circuits. The pressure sensor 8 is connected with the controller 10, and a signal indicating a detection value of the pressure sensor 8 is input into the controller 10. In addition, each unit of the DAC apparatus 100, which includes the fan 3, the vacuum pump 5, the heat exchanger 7, and control valves (the atmospheric control valves 1a and 1b, and the vacuum control valve 4a), is connected with the controller 10, and a control signal is transmitted from the controller 10 to each unit of the DAC apparatus 100.

The controller 10 drives the fan 3 and the vacuum pump 5 to start the heat exchanger 7, and then controls each unit of the DAC apparatus 100 so that the adsorption step, the deaeration step, the desorption step, and the cooling step are performed in the reactor 1 in accordance with a predetermined schedule.

More specifically, in the adsorption step, the controller 10 controls and opens the atmospheric control valves 1a and 1b and closes the vacuum control valve 4a so as to circulate the atmosphere into the reactor 1. In the deaeration step, the atmospheric control valves 1a and 1b are controlled to be closed, and the vacuum control valve 4a is controlled to be opened to depressurize the inside of the adsorption chamber of the reactor 1. In the desorption step, the atmospheric control valves 1a and 1b are controlled to be closed, the vacuum control valve 4a is controlled to be opened, and the heat exchanger 7 is controlled to heat the adsorbent so as to desorb and recover CO₂ from the adsorbent. In the cooling step, the atmospheric control valves 1a and 1b and the vacuum control valve 4a are controlled to be closed, and the heat exchanger 7 is controlled to cool the adsorbent.

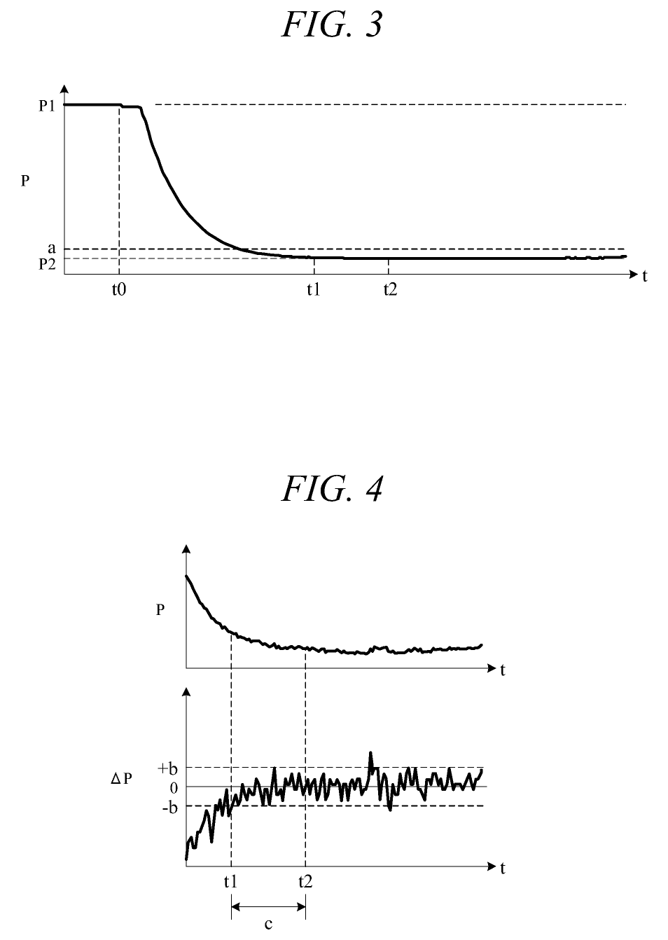

FIGS. 3 and 4 are time charts for describing pressure changes in the adsorption chamber in the deaeration step, and illustrate pressure P of the reactor 1. FIG. 4 also illustrates a change amount ΔP per unit time (for example, approximately one second) of the pressure P of the reactor 1. As illustrated in FIG. 3, when the deaeration step is started at time t0, the pressure P of the reactor 1 that has been atmospheric pressure P1 in the adsorption step until then gradually decreases to final ultimate pressure P2 of the vacuum pump 5, and becomes stable.

As illustrated in FIG. 4, the change amount |ΔP| of the pressure P of the reactor 1 gradually decreases, as the pressure P of the reactor 1 approaches the final ultimate pressure P2 of the vacuum pump 5. After the controller 10 starts the deaeration step, when a state in which the change amount |ΔP| per unit time of the pressure P that has been detected by the pressure sensor 8 is equal to or smaller than a predetermined amount “b” continues for a predetermined time “c” (for example, approximately 30 seconds), the controller 10 ends the deaeration step. That is, it is determined that deaeration has been sufficiently conducted, the oxygen partial pressure in the adsorption chamber has been reduced sufficiently, and the deaeration has been completed, and then the deaeration step ends.

In the example of FIG. 4, a state in which the change amount |ΔP| is equal to or smaller than the predetermined amount “b” (for example, approximately 0.25 kPa) continues for the predetermined time “c” from time t1 to time t2, and then the deaeration step ends at time t2. In this manner, by monitoring the change amount |ΔP| of the pressure P of the reactor 1, it becomes possible to accurately and promptly determine completion of the deaeration regardless of the environmental condition such as humidity, so that the time necessary for the deaeration step can be shortened.

Furthermore, the controller 10 determines the completion of the deaeration on condition that the pressure P that has been detected by the pressure sensor 8 is equal to or lower than predetermined pressure “a” (for example, approximately 10 kPa), which is set to be lower than the atmospheric pressure, and then ends the deaeration step. Thus, after the deaeration step starts and before the pressure reduction in the adsorption chamber is actually started, even though the period of time while the pressure P that has been detected by the pressure sensor 8 is stable near the atmospheric pressure P1 becomes equal to or longer than the predetermined time “c”, the completion of the deaeration is not determined, and the deaeration step does not end.

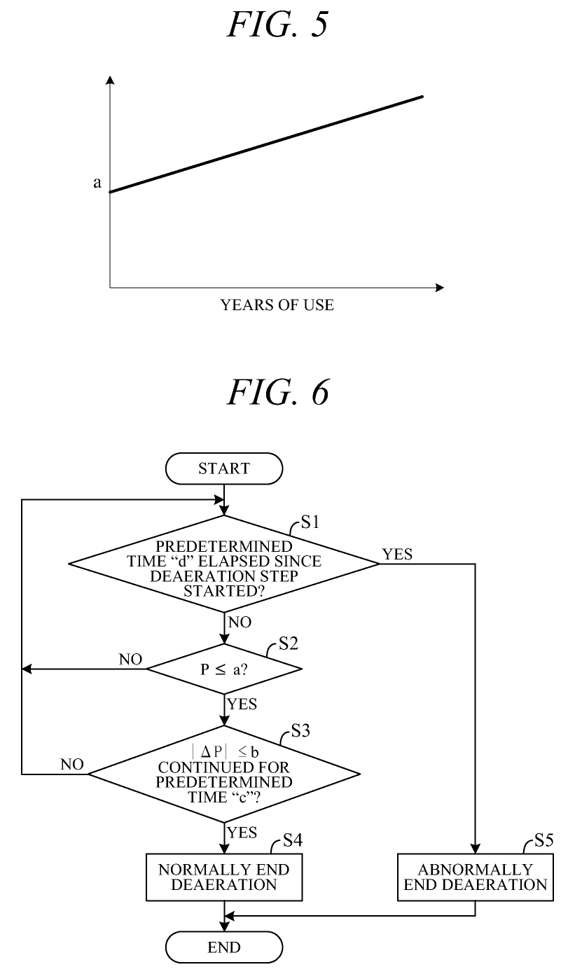

FIG. 5 is a diagram for describing a characteristic of the predetermined pressure “a” in accordance with the years of use of the vacuum pump 5. The exhaust amount of the vacuum pump 5 gradually decreases in accordance with degradation over time. For this reason, the final ultimate pressure P2 of the vacuum pump 5 gradually changes in accordance with not only the environmental condition such as humidity at present but also degradation over time, and increases, as years of use of the vacuum pump 5 increase. The controller 10 sets to increase the predetermined pressure “a”, as years of use of the vacuum pump 5 increase, based on the years of use of the vacuum pump 5 at present and the characteristic of the predetermined pressure “a” as illustrated in FIG. 5 within a range in which the oxidation deterioration of the adsorbent can be prevented. In this manner, by setting the appropriate predetermined pressure “a” in accordance with the state of degradation over time of the vacuum pump 5, it becomes possible to more appropriately determine the completion of the deaeration while preventing the oxidation deterioration of the adsorbent. The years of use of the vacuum pump 5 may be calculated, based on the total operation time of the DAC apparatus 100, may be calculated, based on the installation period of the DAC apparatus 100, or may be calculated, based on the total operation time and the installation period of the DAC apparatus 100.

FIG. 6 is a flowchart illustrating an example of processing in the deaeration step performed by the controller 10 in FIG. 2. As illustrated in FIG. 6, the controller 10 first controls and closes the atmospheric control valves 1a and 1b and opens the vacuum control valve 4a to start the depressurization and deaeration of the reactor 1 in S1 (S: processing step), and then determines whether a predetermined time “d” (for example, approximately 300 seconds) has elapsed. The predetermined time “d” is determined beforehand as the maximum value of the time necessary for the deaeration step in a normal state in which there is no failure in each unit of the DAC apparatus 100. Immediately after the deaeration is started, a negative determination is made in S1, and the processing proceeds to S2.

In S2, it is determined whether the pressure P that has been detected by the pressure sensor 8 is equal to or lower than the predetermined pressure “a”. In a case where an affirmative determination is made in S2, the processing proceeds to S3, and it is determined whether a state in which the change amount |ΔP| of the pressure P is equal to or smaller than the predetermined amount “b” has continued for the predetermined time “c”. In a case where an affirmative determination is made in S3, the processing proceeds to S4, completion of the deaeration is determined, and the deaeration step ends. The heat exchanger 7 is controlled to heat the adsorbent, and the desorption step is started.

In a case where a negative determination is made in S2 or S3, the processing returns to S1. When the predetermined time “d” elapses while the pressure P that has been detected by the pressure sensor 8 does not decrease or is not stable, the affirmative determination is made in S1, and the processing proceeds to S5. It is determined that some abnormality related to deaeration is occurring, the deaeration step ends, and the DAC apparatus 100 is stopped.

Thus, regardless of the final ultimate pressure P2 of the vacuum pump 5, at the timing (time t2 in FIG. 4) when the state in which the change amount |ΔP| of the pressure P that has been detected by the pressure sensor 8 is equal to or smaller than the predetermined amount “b” continues for the predetermined time “c”, it is possible to determine completion of the deaeration, and to end the deaeration step (S3 to S4). In addition, because of the condition that the pressure P that has been detected by the pressure sensor 8 is equal to or lower than the predetermined pressure “a”, the completion of the deaeration is not determined in a state in which the pressure P is stable near the atmospheric pressure P1, and it becomes possible to appropriately determine the completion of the deaeration (S2 to S4).

According to the embodiments of the present invention, the following operation and effects are achievable.

(1) The DAC apparatus 100 includes: the reactor 1 in which an adsorbent for adsorbing or absorbing CO₂ is provided; the atmospheric control valves 1a and 1b, which open the reactor 1 to the atmosphere or seal the reactor 1 from the atmosphere; the vacuum pump 5 connected with the reactor 1 through the vacuum piping 4; the vacuum control valve 4a provided on the vacuum piping 4; the heat exchanger 7, which heats the adsorbent; the pressure sensor 8, which detects pressure P of the reactor 1; and the controller 10 configured to control the atmospheric control valves 1a and 1b, the vacuum control valve 4a, and the heat exchanger 7 to sequentially perform an adsorption step, a deaeration step, and a desorption step, the adsorption step circulating the atmosphere into the reactor 1, and adsorbing CO₂ in the atmosphere to the adsorbent, the deaeration step deaerating and depressurizing the atmosphere in the reactor 1, the desorption step heating the adsorbent in a state in which the reactor 1 is depressurized, and desorbing CO₂ from the adsorbent (FIGS. 1 and 2).

After the deaeration step is started, when a state in which the change amount |ΔP| per unit time of the pressure P that has been detected by the pressure sensor 8 is equal to or smaller than the predetermined amount “b” continues for the predetermined time “c”, the controller 10 ends the deaeration step (S3 to S4 in FIG. 6). Thus, by promptly determining the completion of the deaeration regardless of the environmental condition such as humidity, and shortening the time necessary for the deaeration step, the CO₂ recovery efficiency of the entire apparatus can be improved. In addition, it is determined that the deaeration is sufficiently conducted, the oxygen partial pressure in the adsorption chamber is sufficiently lowered, and the deaeration is completed. Then, the deaeration step ends, and the desorption step accompanied with the temperature rise of the adsorbent is started, so that the oxidation deterioration of the adsorbent can be certainly prevented.

(2) After starting the deaeration step, the controller 10 ends the deaeration step on condition that the pressure P that has been detected by the pressure sensor 8 is equal to or lower than the predetermined pressure “a”, which is set to be lower than the atmospheric pressure (S2 to S4 in FIG. 6). Thus, the completion of the deaeration is not determined in a state in which the pressure P is stable near the atmospheric pressure P1, so that the completion of the deaeration can be appropriately determined.

(3) The predetermined pressure “a” is set to increase, as years of use of the vacuum pump 5 increase (FIG. 5). By setting appropriate predetermined pressure “a” in accordance with the state of degradation over time of the vacuum pump 5, the completion of the deaeration can be determined in a more appropriate manner.

The above embodiment can be combined as desired with one or more of the aforesaid modifications. The modifications can also be combined with one another.

According to the present invention, it becomes possible to shorten the time necessary for the deaeration step and improve the CO₂ recovery efficiency.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂;
an atmospheric control valve configured to open the adsorption chamber to the atmosphere or seal the adsorption chamber from the atmosphere;
a vacuum pump connected with the adsorption chamber through vacuum piping;
a vacuum control valve provided on the vacuum piping;
a heating device configured to heat the adsorbent;
a pressure sensor configured to detect a pressure of the adsorption chamber; and
a controller configured to control the atmospheric control valve, the vacuum control valve, and the heating device to sequentially perform an adsorption step, a deaeration step, and a desorption step, the adsorption step circulating the atmosphere into the adsorption chamber and adsorbing CO₂ in the atmosphere to the adsorbent, the deaeration step deaerating and depressurizing the atmosphere in the adsorption chamber, the desorption step heating the adsorbent in a state in which the adsorption chamber is depressurized and desorbing CO₂ from the adsorbent, wherein
the controller ends the deaeration step when a state in which a change amount per unit time of the pressure detected by the pressure sensor is equal to or smaller than a predetermined amount continues for a predetermined time after starting the deaeration step.

2. The DAC apparatus according to claim 1, wherein
the controller ends the deaeration step on condition that the pressure detected by the pressure sensor is equal to or lower than a predetermined pressure set to be lower than the atmospheric pressure after starting the deaeration step.

3. The DAC apparatus according to claim 2, wherein
the predetermined pressure is set to increase as years of use of the vacuum pump increase.
